(19) United States
(12) Patent Application Publication
(10) Pub. No.: US 2023/0190555 A1
(43) Pub. Date: Jun. 22, 2023

(54) EASY AMBLER

(71) Applicant: Samantha Todd, Strongsville, OH (US)

(72) Inventor: Samantha Todd, Strongsville, OH (US)

(21) Appl. No.: 18/086,114

(22) Filed: Dec. 21, 2022

Related U.S. Application Data
(60) Provisional application No. 63/292,480, filed on Dec. 22, 2021.

(51) Int. Cl. A61G 7/10

(52) U.S. Cl. CPC A61G 7/1038

(57) ABSTRACT

A walker constructed of first and second shaft each having a first and second handle at one end. First and second support braces interconnecting the first and second shafts. The first and second shafts each having an upper section and a lower section wherein the upper sections are housed within the lower sections. First and second support braces mounted to an upper end of the first and second shafts grasp a mounted element to assist the user in standing from a seated position.

### CROSS-REFERENCE TO RELATED APPLICATIONS

This application claims the benefit of U.S. Provisional Patent Application No. 63/292,480 filed on Dec. 22, 2021, which is incorporated herein by reference.

### TECHNICAL FIELD

The present invention relates generally to a device for assisting people who are recovering from various types of injuries and surgery, or who are experiencing weakness or instability from conditions associated with advanced age or other causes, specifically, the present invention relates generally to a device for assisting people who are moving to and from a seated position.

### BACKGROUND OF THE INVENTION

Various types of devices have been employed to assist people who are recovering from various types of injuries and surgery, or who are experiencing weakness or instability from conditions associated with advanced age or other causes, in moving to and from a seated position. Complicated and expensive devices such as tilting chairs and the like have been developed for such purposes.

A walker or walking frame is a tool for disabled or elderly people who need additional support to maintain balance or stability while walking. Walkers started appearing in the early 1950s. The basic design of a walker for adults is a frame approximately waist high, approximately twelve inches deep and slightly wider than the width of a human being. Walkers are also available in other sizes such as pediatric (for children) or bariatric (for obese individuals).

Modern walkers are height adjustable and are typically set at a height that is comfortable for the user while allowing the user to maintain a slight bend in their arms. The bend is needed to permit for proper blood circulation through the user's arms as the walker is used. The front two legs of the walker may or may not have wheels attached thereto, depending on the strength and abilities of the person using it. Caster wheels or slides are also commonly seen on the back legs of a walker with wheels on the front.

During the use of a walker, the person walks with the frame surrounding their front and sides and their hands provide additional support by holding onto the top of the sides of the walker frame. Traditionally, a walker is picked up and placed a short distance ahead of the user. The user then walks to it and repeats the process. With the use of wheels and glides, the user may push the walker ahead as opposed to picking it up. This makes for easier use of the walker, as there is no requirement of the user to use their arms to lift the walker. This is beneficial for those with little arm strength. A walker is a good tool for those who are recuperating from leg or back injuries and is also commonly used by individuals having problems with walking or with mild balance problems.

### SUMMARY OF THE PRESENT INVENTION

According to an embodiment of the invention, a walker constructed of first and second shaft each has a first and second handle at one end. First and second support braces interconnecting the first and second shafts. The first and second shafts each have an upper section and a lower section wherein the upper sections are housed within the lower sections. First and second support braces are mounted to an upper end of the first and second shafts to grasp a mounted element to assist the user in standing from a seated position.

According to another embodiment of the invention, a walker has first and second shafts, each having a first and second handle, respectively, at one end. First and second support braces interconnect the first and second shafts. The first and second shafts each have an upper section and a lower section wherein the lower sections are housed within the upper sections. First and second support braces are mounted to an upper end of the first and second shafts to grasp a mounted element to assist the user in standing from a seated position.

### BRIEF DESCRIPTION OF THE DRAWINGS

The structure, operation, and advantages of the present invention will become further apparent upon consideration of the following description taken in conjunction with the accompanying figures (FIGs.). The figures are intended to be illustrative, not limiting. Certain elements in some of the figures may be omitted, or illustrated not-to-scale, for illustrative clarity. The cross-sectional views may be in the form of “slices”, or “near-sighted” cross-sectional views, omitting certain background lines which would otherwise be visible in a “true” cross-sectional view, for illustrative clarity.

In the drawings accompanying the description that follows, both reference numerals and legends (labels, text descriptions) may be used to identify elements. If legends are provided, they are intended merely as an aid to the reader and should not in any way be interpreted as limiting.

FIG. 1 is a front, three-dimensional view of a first embodiment of a walker with support braces, in accordance with the present invention.

FIG. 2 is a front, three-dimensional view of another a second embodiment of a walker with support braces, in accordance with the present invention.

### DETAILED DESCRIPTION OF THE PREFERRED EMBODIMENTS

In the description that follows, numerous details are set forth in order to provide a thorough understanding of the present invention. It will be appreciated by those skilled in the art that variations of these specific details are possible while still achieving the results of the present invention. Well-known processing steps are generally not described in detail in order to avoid unnecessarily obfuscating the description of the present invention.

In the description that follows, exemplary dimensions may be presented for an illustrative embodiment of the invention. The dimensions should not be interpreted as limiting. They are included to provide a sense of proportion. Generally speaking, it is the relationship between various elements, where they are located, their contrasting compositions, and sometimes their relative sizes that is of significance.

In the drawings accompanying the description that follows, often both reference numerals and legends (labels, text descriptions) will be used to identify elements. If legends are provided, they are intended merely as an aid to the reader and should not in any way be interpreted as limiting.

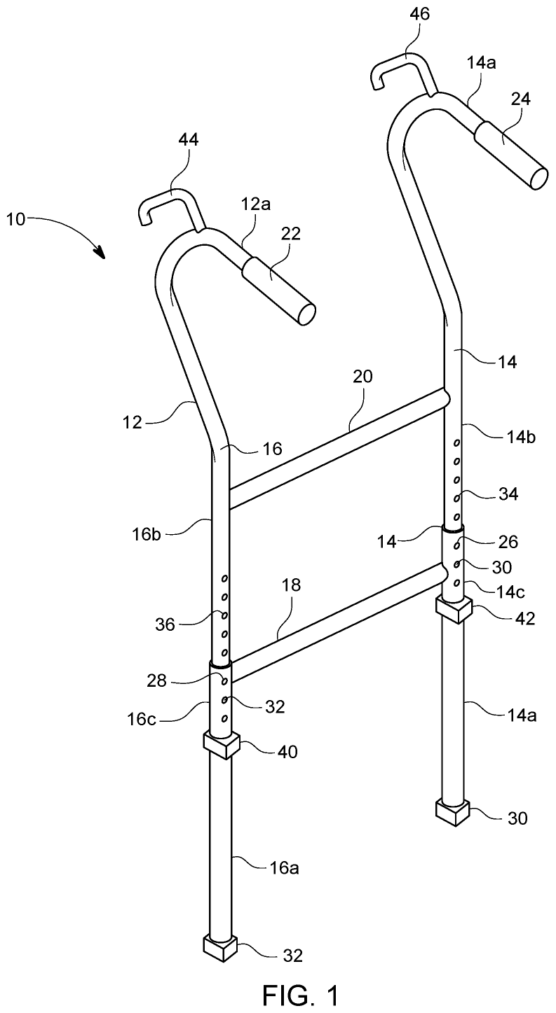

The present invention is directed to a walking assistance device 10 (hereafter “assistance device”), as shown in FIG. 1. The term “walker” refers to a class of portable assist devices 10 which enable an invalid or an elderly person to walk about. Typically, a walker comprises a frame 12 including generally a pair of upright, generally vertical legs 14 and 16. The legs 14 and 16 are interconnected by a lower supporting brace member 18 and an upper support brace member 20. Typically, a walker 10 is made from lightweight aluminum tubing, and the legs may be telescopic and the entire structure collapsible to provide ease in storage. In use, an invalid or elderly person holds upper hand supports 22 and 24, located at the ends of the legs 14 and 16 and after taking a step or two, lifts the walker and moves it forwardly so that the next steps may be taken.

When rising from a sitting position, elderly or invalid persons often find it quite difficult to move to a standing position. If a walker is used to pull the user into the standing position, frequently the walker tends to pivot about the lower end portions 14a and 16a of the vertical legs 14 and 16. This results in the person experiencing difficulty in rising to the standing position, and often causes instability which may result in the person falling or becoming injured.

The walker 10 with support braces 18 and 20 is a two-legged walker useful as a mobility assisting device that provides assistance to an impaired person while walking. The concept comprises both apparatus and an associated method for enabling an invalid or elderly person to rise unassisted from a sitting position in a bench or the like into the standing position.

Accordingly, it is an object of the invention to provide a two-legged walker 10, incorporating lower and upper support braces 18 and 20 to assist the user. The walker 10 with support braces 18 and 20 may be constructed of any material selected by those of skill in the art including metal, polymer, fiberglass, 25% to 40% fiberglass filed nylon, or any combination or composite thereof. In a preferred embodiment, portions of the walker 10 are aluminum. The various types of the walker 10 may be formed, for example, of 1.0 inch diameter aluminum tubing having a 0.0125 inch wall thickness, which is known in the art and common for such applications.

As illustrated in FIG. 1, the walker 10 is formed of first and second vertical legs 14 and 16, also called shafts herein, each having first and second handles 22 and 24 mounted to an upper end 12a and 14a of the legs. An upper support brace 20 is mounted between the first and second vertical legs 14 and 16. A lower support brace 18 is mounted between the first and second vertical legs 14 and 16 at a location below the upper support brace 20. The upper and lower support braces 20 and 18 are mounted between the shafts 14 and 16, respectively, below the first and second handles 22 and 24.

The first and second shafts 14 and 16 are identical in dimension and shape and are arranged parallel with respect to each other and extend in a vertical direction from the floor. Each of the shafts 14 and 16 are formed as tubular portions, having a lower section 14a and 16a, and an upper sections 14b and 16b, respectively.

The upper sections 14b and 16b are each housed within the lower sections 14c and 16c, respectively. Each of the lower sections 14c and 16c have outer diameters greater than the outer diameters of the upper sections 14b and 16b, such that the upper sections 14b and 16b are slidably inserted into the lower sections 14c and 16c, and are secured therein with first and second pins 28 which extend through a series of openings 30 and 32 through lower sections 14c and 16c and a series of openings 34 and 36 in each of the lower ends of the upper sections 14b and 16b. Thus, the first and second shafts 14 and 16 are adjustable in height by raising or lowering the upper sections 14b and 16b with respect to the lower sections 14a and 16a and locking them into place with locking means 40 and 42.

Mounted to the bottom of the lower sections 14a and 16a are first and second feet 30 and 32. The feet 30 and 32 normally engage the ground when the walker 10 is in use. The feet 30 and 32 are designed to make the use of the walker 10 more comfortable for the user by contacting the ground and absorbing shock, as well as providing a non-slip surface. The feet 30 and 32 can be constructed of materials selected from the group comprising rubber, silicone, and neoprene.

The first and second shafts 12 and 14 are adjoined utilizing first and second support braces 18 and 20 mounted between the first and second vertical legs 14 and 16. The first supporting brace 18 is mounted at either end to the lower sections lower section 14a and 16a of the shafts 14 and 16. The lower sections 14c and 16c are secured to the lower sections 14a and 16a by first and second locking means 40 and 42. The locking means may include any suitable mechanism, such as bolts and clamps.

There are first and second handles 22 and 24 mounted to the tops of the upper sections 12a and 14a, respectively. The handles 24 and 26 are designed to assist the user in holding on to the walker with support braces 10. Further, the handles 24 and 26 support the user in using the walker 10 as an aid to other movements, including standing or sitting. The first and second handles 24 and 26 are preferably constructed of a non-slip material such as rubber. The handles 24 and 26 may each include a lanyard (not shown) connected thereto, which may be threaded about the user's wrists to ensure they retain the handles 24 and 26.

Mounted adjacently below the first and second handles 22 and 24 are first and second support braces 44 and 46. The support braces 44 and 46 are formed as U-shaped hooks, such that they may be used to grasp mounted elements to assist the user in standing from a seated position. The U-shaped hooks extend upward from the handles 22 and 24 with the bottom of the u-shape extending parallel to the upper end 12a and 14a of the legs in the opposite direction of the handles 22 and 24. The free ends of the U-shaped hooks point downward toward the support brace 20. For example, if a user is sitting on a church pew, the user may use the support braces 44 and 46 to hook about the back portion of the pew in front of the user, and lift themself into the standing position. The hooks can also be rotated 180 degrees in order to use them as a hanging apparatus for bags, purses, etc.

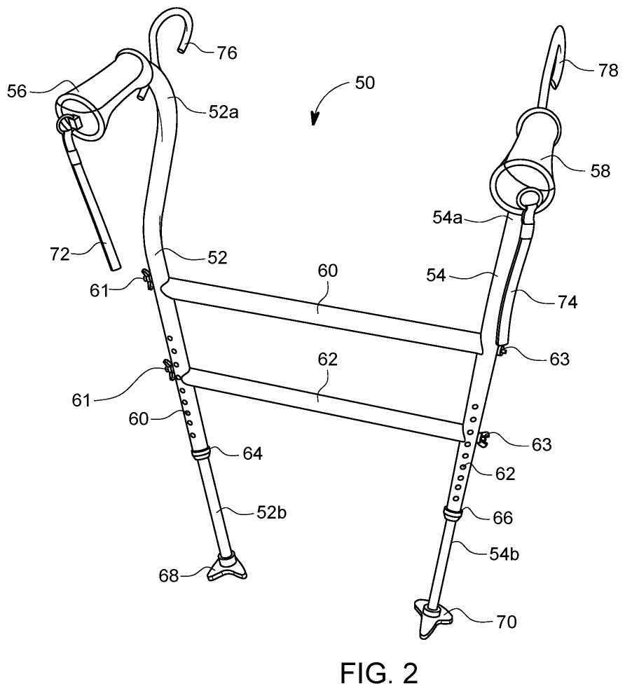

Referring to FIG. 2, there is illustrated an alternative embodiment of the walker 50 formed of first and second vertical legs 52 and 54, also called shafts herein, each having first and second handles 56 and 58 mounted to an upper end 52a and 54a of the legs. An upper support brace 60 is mounted between the first and second vertical legs 52 and 54. A lower support brace 62 is mounted between the first and second vertical legs 52 and 54 at a location below the upper support brace 60. The upper and lower support braces 60 and 62 are mounted by bolts 61 and 63 between the shafts 52 and 54, respectively, below the first and second handles 56 and 58.

The first and second shafts 52 and 54 are identical in dimension and shape and are arranged parallel with respect to each other and extend in a vertical direction from the floor. Each of the shafts 52 and 54 are formed as tubular portions, having a lower section 52b and 54b, and an upper sections 52a and 54a, respectively.

The lower sections 52b and 54b are each housed within the upper sections 52a and 54a, respectively. Each of the upper sections 52a and 54a have outer diameters greater than the outer diameters of the lower sections 52b and 54b, such that the lower sections 52b and 54b are slidably inserted into the upper sections 52a and 54a, and are secured therein with first and second pins 60 and 62 which extend through a series of openings 64 and 66 through upper sections 52a and 54a and a series of openings (not shown) through the upper ends of the lower sections 52b and 54b. Thus, the first and second shafts 52 and 54 are adjustable in height by raising or lowering the lower sections 52b and 54b with respect to the upper sections 52a and 54a and locking them into place with the first and second pins 60 and 62 and/or with the plastic clamps 64 and 66.

Mounted to the bottom of the lower sections 52b and 54b are first and second feet 68 and 70. The feet 68 and 70 normally engage the ground when the walker 50 is in use. The feet 68 and 70 are designed to make the use of the walker 50 more comfortable for the user by contacting the ground and absorbing shock, as well as providing a non-slip surface. The feet 68 and 70 can be constructed of materials selected from the group comprising rubber, silicone, and neoprene.

The first and second shafts 12 and 14 are adjoined utilizing first and second support braces 18 and 20 mounted between the first and second vertical legs 14 and 16. The first supporting brace 18 is mounted at either end to the lower sections lower section 14a and 16a of the shafts 14 and 16. The lower sections 14c and 16c are secured to the lower sections 14a and 16a by first and second locking means 40 and 42. The locking means may include any suitable mechanism, such as bolts and clamps.

There are first and second handles 56 and 58 mounted to the tops of the upper sections 52a and 54a, respectively. The handles 56 and 58 are designed to assist the user in holding on to the walker with support braces 50. Further, the handles 56 and 58 support the user in using the walker 50 as an aid to other movements, including standing or sitting. The first and second handles 56 and 58 are preferably constructed of a non-slip material such as rubber. The handles 56 and 58 may each include a lanyard 72 and 74, respectively, connected thereto, which may be threaded about the user's wrists to ensure they retain the handles 56 and 58.

Mounted at the end of the first and second handles 56 and 58 are first and second support braces 76 and 78. The support braces 44 and 46 are formed as U-shaped hooks, in the same manner as hooks 44 and 46 in the embodiment shown in FIG. 1 such that they may be used to grasp mounted elements to assist the user in standing from a seated position. For example, if a user is sitting on a church pew, the user may use the support braces 76 and 78 to hook about the back portion of the pew in front of him, and lift himself into the standing position. The hooks can also be rotated 180 degrees in order to use them as a hanging apparatus for bags, purses, etc.

Although the invention has been shown and described with respect to a certain preferred embodiment or embodiments, certain equivalent alterations and modifications will occur to others skilled in the art upon the reading and understanding of this specification and the annexed drawings. In particular regard to the various functions performed by the above described components (assemblies, devices, etc.) the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application.

1. An improved walker, comprising:
first and second shafts, each having a first and second handle, respectively, at one end;
first and second support braces interconnecting the first and second shafts;
the first and second shafts each having an upper section and a lower section wherein the upper sections are housed within the lower sections; and
first and second support braces mounted to an upper end of the first and second shafts to grasp a mounted element to assist the user in standing from a seated position.

2. The improved walker of claim 1 wherein the first and second shafts are vertical shafts.

3. The improved walker of claim 2 wherein the support braces are formed as U-shaped hooks.

4. The improved walker of claim 2 wherein the U-shaped hooks extend upward from the first and second handles with a bottom of the u-shaped hook extending parallel to the upper section of the first and second shafts in the opposite direction from the first and second handles.

5. The improved walker of claim 4 wherein each of the first and second shafts have lower sections having a greater outer diameter than outer diameters of an upper section of the first and second shafts has whereby the upper sections can be slidably inserted into the lower sections of the first and second shafts.

6. The improved walker of claim 5 wherein non-slip feet are mounted to the lower section of the first and second shafts.

7. The improved walker of claim 6 wherein the upper and lower sections of the first and second shafts are formed as tubular portions.

8. The improved walker of claim 5 including a series of openings through lower sections of the first and second shafts and a series of corresponding openings in each of the lower ends of the upper sections.

9. The improved walker of claim 8 including first and second pins adapted to extend through the series of openings through lower sections of the first and second shafts and the series of corresponding openings in each of the lower ends of the upper sections to adjust the height of the walker.

10. The improved walker of claim 9 including first and second pins adapted to extend through the series of openings through lower sections of the first and second shafts and the series of corresponding openings in each of the lower ends of the upper sections to adjust the height of the walker by raising or lowering the upper sections of the first and second shafts with respect to the lower sections of the first and second shafts.

11. An improved walker, comprising:
first and second shafts, each having a first and second handle, respectively, at one end;
first and second support braces interconnecting the first and second shafts;
the first and second shafts each having an upper section and a lower section wherein the lower sections are housed within the upper sections; and
first and second support braces mounted to an upper end of the first and second shafts to grasp a mounted element to assist the user in standing from a seated position.

12. The improved walker of claim 11 wherein the first and second shafts are vertical shafts.

13. The improved walker of claim 12 wherein the support braces are formed as U-shaped hooks.

14. The improved walker of claim 13 wherein the U-shaped hooks extend upward from the first and second handles with a bottom of the u-shaped hook extending parallel to the upper section of the first and second shafts in the opposite direction from the first and second handles.

15. The improved walker of claim 14 wherein each of the first and second shafts have lower sections having a smaller outer diameter than outer diameters of an upper section of the first and second shafts has whereby the lower sections can be slidably inserted into the upper sections of the first and second shafts.

16. The improved walker of claim 15 wherein non-slip feet are mounted to the lower section of the first and second shafts.

17. The improved walker of claim 16 wherein the upper and lower sections of the first and second shafts are formed as tubular portions.

18. The improved walker of claim 17 including a series of openings through upper sections of the first and second shafts and a series of corresponding openings in each of the upper ends of the lower sections.

19. The improved walker of claim 18 including first and second pins adapted to extend through the series of openings through the upper sections of the first and second shafts and the series of corresponding openings in each of the upper ends of the lower sections to adjust the height of the walker.

20. The improved walker of claim 19 including first and second pins adapted to extend through the series of openings through upper sections of the first and second shafts and the series of corresponding openings in each of the upper ends of the lower sections to adjust the height of the walker by raising or lowering the upper sections of the first and second shafts with respect to the lower sections of the first and second shafts.
